(19) United States
(12) Patent Application Publication
(10) Pub. No.: US 2025/0238966 A1
(43) Pub. Date: Jul. 24, 2025

(54) SYSTEM AND METHOD FOR DYNAMIC AVATAR UPDATES

(71) Applicant: Wells Fargo Bank, N.A., San Francisco, CA (US)

(72) Inventor: Anthony Scott Best, Huntersville, NC (US)

(21) Appl. No.: 18/149,369

(22) Filed: Jan. 3, 2023

(51) Int. Cl. G06T 11/00; G06N 3/092; G06Q 40/02

(52) U.S. Cl. CPC G06T 11/00; G06N 3/092; G06Q 40/02

(57) ABSTRACT

A method may include generating a digital avatar data structure; associating the digital avatar data structure with a user account; presenting an original appearance of a digital avatar in a user interface based on appearance values in the digital avatar data structure; receiving an indication of user financial activity associated with the user account; in response to receiving the indication, inputting the user financial activity into a machine learning model; updating the appearance values of the digital avatar data structure based on an output of the machine learning model; and presenting an updated appearance of the digital avatar after the updating in accordance with the updated appearance values

### BACKGROUND

Apps on mobile devices serve many purposes. For example, a user may have an app that connects with the financial institution so that they may transfer money, see their account balances, etc. Another app may be used to manage their calendar and another their to-do lists. The apps generally are information dense. As such the apps often fail to provide quick information at a glance.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawing.

FIG. 1 is an illustration of components of a client device and an application server, according to various examples.

FIG. 2 is a schematic representation of processing user financial activity, according to various examples.

FIG. 3 is a user interface, according to various examples.

FIG. 4 is a flowchart illustrating a method to compare objects in a knowledge graph, according to various examples.

FIG. 5 is a block diagram illustrating a machine in the example form of computer system 500, within which a set or sequence of instructions may be executed to cause the machine to perform any one of the methodologies discussed herein, according to various examples.

### DETAILED DESCRIPTION

In the following description, for purposes of explanation, numerous specific details are set forth to provide a thorough understanding of some example embodiments. It will be evident, however, to one skilled in the art that the present invention may be practiced without these specific details.

Throughout this disclosure, electronic actions may be performed by components in response to different variable values (e.g., thresholds, user preferences, etc.). As a matter of convenience, this disclosure does not always detail where the variables are stored or how they are retrieved. In such instances, it may be assumed that the variables are stored on a storage device (e.g., Random Access Memory (RAM), cache, hard drive) accessible by the component via an Application Programming Interface (API) or other program communication method. Similarly, the variables may be assumed to have default values should a specific value not be described. User interfaces may be provided for an end-user or administrator to edit the variable values in some instances.

In various examples described herein, user interfaces are described as being presented to a computing device. Presentation may include data transmitted (e.g., a hypertext markup language file) from a first device (such as a web server) to the computing device for rendering on a display device of the computing device via a web browser. Presenting may separately (or in addition to the previous data transmission) include an application (e.g., a stand-alone application) on the computing device generating and rendering the user interface on a display device of the computing device without receiving data from a server.

Furthermore, the user interfaces are often described as having different portions or elements. Although in some examples these portions may be displayed on a screen at the same time, in other examples the portions/elements may be displayed on separate screens such that not all the portions/elements are displayed simultaneously. Unless explicitly indicated as such, the use of “presenting a user interface” does not infer either one of these options.

Additionally, the elements and portions are sometimes described as being configured for a certain purpose. For example, an input element may be described as configured to receive an input string. In this context, “configured to” may mean presentation of a user interface element that can receive user input. Thus, the input element may be an empty text box or a drop-down menu, among others. “Configured to” may additionally mean computer executable code processes interactions with the element/portion based on an event handler. Thus, a “search” button element may be configured to pass text received in the input element to a search routine that formats and executes a structured query language (SQL) query with respect to a database.

Information is presented to users of an app in several ways. For example, if the app is financial application, pie-charts may be presented that show the mixture of invested assets for a user or a line chart showing their net worth over time. Within the app, a user may perform various actions as well. For example, a user may research an investment, change their contribution to a retirement accounts, pay bills etc. Accordingly, the user may be able to view quantitative information on their accounts. The app, however, may not present qualitative information related to their financial health. For example, a user may be unaware that they are failing to take the necessary actions to avoid bouncing a check, retiring at their desired age, etc. Described herein are system and methods that use a digital avatar that conveys

information via expressions and appearance based on the output of a machine learning model. The expressions may correlate with actions taken by the user within the app or actions related to the purpose of the app. For example, a user making a large purchase may be used to update the digital avatar—as well as a user checking their balance. A user's digital avatar may be transmitted to others such that is appears in friend's/family member's instances of the app. In this manner, other users may gather insights into a person's financial health while maintaining the privacy of the actual account balances, etc. As will be appreciated by one of ordinary skill in the art, the disclosure describes several benefits in the areas of user interface design, data privacy, and machine learning models.

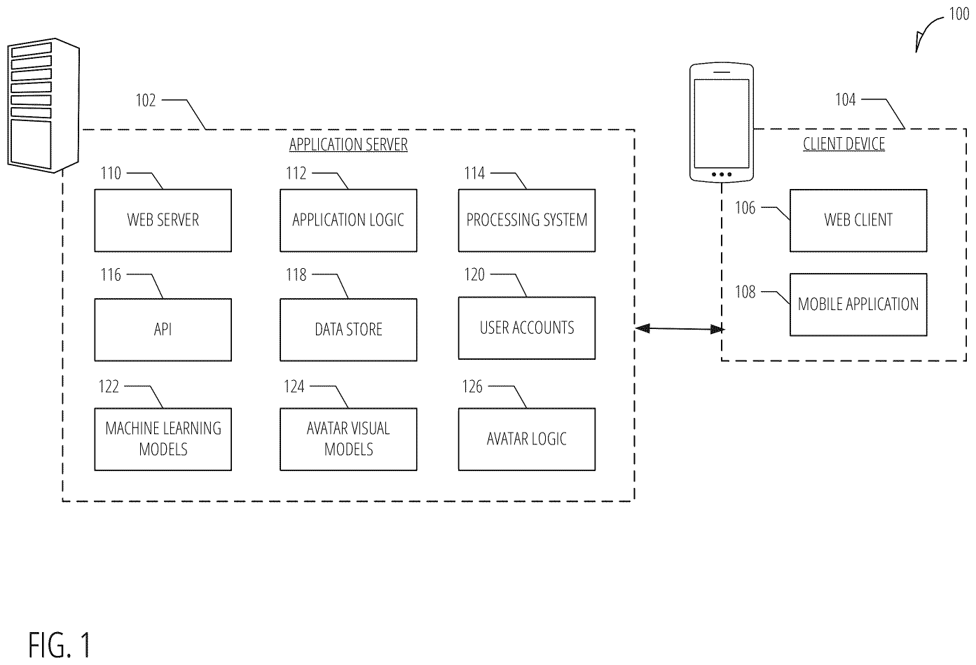

FIG. 1 is an illustration of components of a client device and an application server, according to various examples. FIG. 1 includes an application server 102, a client device 104, a web client 106, a mobile application 108, a web server 110, an application logic 112, a processing system 114, an API 116, a data store 118, a user accounts 120, a machine learning models 122, an avatar visualization models 124, and an avatar logic 126.

Application server 102 is illustrated as set of separate elements (e.g., component, logic, etc.). However, the functionality of multiple, individual elements may be performed by a single element. An element may represent computer program code that is executable by processing system 114. The program code may be stored on a storage device (e.g., data store 118) and loaded into a memory of the processing system 114 for execution. Portions of the program code may be executed in a parallel across multiple processing units (e.g., a core of a general-purpose computer processor, a graphical processing unit, an application specific integrated circuit, etc.) of processing system 114. Execution of the code may be performed on a single device or distributed across multiple devices. In some examples, the program code may be executed on a cloud platform (e.g., MICROSOFT AZURE® and AMAZON EC2®) using shared computing infrastructure.

Some or all components of application server 102 may be part of client device 104. For example, machine learning models 122, avatar visualization models 124, and avatar logic 126 may be stored on a data store of client device 104 and execute locally using a processing unit of client device 104.

Client device 104 may be a computing device which may be, but is not limited to, a smartphone, tablet, laptop, multi-processor system, microprocessor-based or programmable consumer electronics, game console, set-top box, or another device that a user utilizes to communicate over a network. In various examples, a computing device includes a display module (not shown) to display information (e.g., in the form of specially configured user interfaces). In some embodiments, computing devices may comprise one or more of a touch screen, camera, keyboard, microphone, or Global Positioning System (GPS) device.

Client device 104 and application server 102 may communicate via a network (not shown). The network may include local-area networks (LAN), wide-area networks (WAN), wireless networks (e.g., 802.11 or cellular network), the Public Switched Telephone Network (PSTN) Network, ad hoc networks, cellular, personal area networks, or peer-to-peer (e.g., Bluetooth®, Wi-Fi Direct), or other combinations or permutations of network protocols and network types. The network may include a single Local Area Network (LAN) or Wide-Area Network (WAN), or combinations of LAN's or WAN's, such as the Internet.

In some examples, the communication may occur using an application programming interface (API) such as API 116. An API provides a method for computing processes to exchange data. A web-based API (e.g., API 116) may permit communications between two or more computing devices such as a client and a server. The API may define a set of HTTP calls according to Representational State Transfer (RESTful) practices. For examples, A RESTful API may define various GET, PUT, POST, DELETE methods to create, replace, update, and delete data stored in a Database (e.g., data store 118). For example, an API call may be used that uses a user action as an input and returns an instruction to update a digital avatar's appearance.

APIs may also be defined in frameworks provided by an operating system (OS) to access data in an application that an application may not regularly be permitted to access. For example, the OS may define an API call to obtain the current location of a mobile device the OS is installed on. In another example, an application provider (e.g., of mobile application 108) may use an API call to request a user be authenticated using a biometric sensor on the mobile device. By segregating any underlying biometric data—e.g., by using a secure element-the risk of unauthorized transmission of the biometric data may be lowered. Additionally, the application may not need to transmit a username and password over the network and instead use a token—thereby preventing any possible interception of the user's actual credentials.

Application server 102 may include web server 110 to enable data exchanges with client device 104 via web client 106. Although generally discussed in the context of delivering webpages via the Hypertext Transfer Protocol (HTTP), other network protocols may be utilized by web server 110 (e.g., File Transfer Protocol, Telnet, Secure Shell, etc.). A user may enter in a uniform resource identifier (URI) into web client 106 (e.g., the INTERNET EXPLORER® web browser by Microsoft Corporation or SAFARI® web browser by Apple Inc.) that corresponds to the logical location (e.g., an Internet Protocol address) of web server 110. In response, web server 110 may transmit a web page that is rendered on a display device of a client device (e.g., a mobile phone, desktop computer, etc.). In various examples, mobile application 108 is implemented at least partially as a web application such that it may receive and present data from web server 110.

Additionally, web server 110 may enable a user to interact with one or more web applications provided in a transmitted web page or mobile application. A web application may provide user interface (UI) components that are rendered on a display device of client device 104. The user may interact (e.g., select, move, enter text into) with the UI components, and based on the interaction, the web application may update one or more portions of the web page. A web application may be executed in whole, or in part, locally on client device 104. The web application may populate the UI components with data from external sources or internal sources (e.g., data store 118) in various examples.

In various examples, the web application may be presented on web client 106 or as part of a downloaded app such as mobile application 108. For discussion purposes mobile application 108 may be considered a financial application such as a banking app. The functionality described herein, however, may be implemented in other applications as well. For example, the digital avatar may appear in multiple applications on a mobile phone or as part of an app on a smart television set, etc.

The web application may be executed according to application logic 112. Application logic 112 may use the various elements of application server 102 to implement the web application. For example, application logic 112 may issue API calls to retrieve or store data from data store 118 and transmit it for display on client device 104. Similarly, data entered by a user into a UI component may be transmitted using API 116 back to the web server. Application logic 112 may use other elements (e.g., machine learning models 122, avatar visualization models 124, avatar logic 126, etc.) of application server 102 to perform functionality associated with the web application as described further herein.

Data store 118 may store data that is used by application server 102. Data store 118 is depicted as singular element but may be multiple data stores. The specific storage layout and model used in by data store 118 may take several forms, and a data store 118 may utilize multiple models. Data store 118 may be, but is not limited to, a relational database (e.g., SQL), non-relational database (NoSQL) a flat file database, object model, document details model, graph database, shared ledger (e.g., blockchain), or a file system hierarchy. Data store 118 may store data on one or more storage devices (e.g., a hard disk, random access memory (RAM), etc.). The storage devices may be in standalone arrays, part of one or more servers, and may be in one or more geographic areas.

Avatar visualization models 124 may be stored as data structures in data store 118. An avatar visualization model may be implemented in several ways. For example, an avatar visualization model may include a lookup table of a plurality of image files that represent various emotional states of a digital avatar using values for the vector-geometry corresponding to the desired appearance. In another example, an avatar visualization model may be a three-dimensional model that is rendered in real time by mobile application 108.

Data structures may be implemented in several manners depending on a programming language of an application or database management system used by an application. For example, if C++ is used the data structure may implemented as a struct or class assistance. In the context of a relational database, a data structure may be defined in a schema. Additionally, when a data structure is characterized as “indicating” or “identifying” it may mean the variable (if in a struct) or cell (if in a table) holds the value.

User accounts 120 may include user profiles on users of application server 102. A user profile may include credential information such as a username and hash of a password. A user may enter in their username and plaintext password to a login page of application server 102 to view their user profile information or interfaces presented by application server 102 in various examples. The login page may be part of a web page or app such as mobile application 108.

A user profile may also include authorization to access other services in which the user has an account (e.g., social media, smart devices, financial services). The authorizations may include a token (e.g., using OAuth) or login credentials that authorize application server 102 to retrieve data from the other services in a defined format such as JavaScript Object Notation (JSON) or extensible markup language (XML) over an API. A reciprocal authorization may also be stored in the user profile that authorizes the other services to access data stored in the user profile. In such a manner, mobile application 108 may have access to other financial information accounts of the user to better understand the user's overall financial health.

A user account may include an identification of their digital avatar and preferences associated with the digital avatar. For example, different users may have different communication preferences. One user may prefer audio encouragement from their digital avatar, while others may want text (e.g., a text bubble), and others may only want the appearance of the avatar to change to convey information. Another communication preference may identify the locations the digital avatar is authorized to appear/communicate. For example, a user may have a smart speaker (e.g., a network-enabled speaker) and permit the digital avatar to relay messages through the smart speaker. The digital avatar may also be used (e.g., as a communication preference) as part of a digital assistant on the mobile application. For example, when a user uses a digital assistant or customer service chat function, the digital avatar may be presented as if it was the one talking to the user

User preferences may also include sharing and privacy preferences. A user may permit their digital avatar's appearance to be displayed with connected users. A user may connect with another by entering in an email address into the app via a user interface input box, which transmits the request to the email address. Upon receipt of the approval of the request (e.g., the receiving user may click on acceptance URL), the user's account may be updated to include an indication that sharing is now enabled between the two users. Another sharing preference may be for the user's social media accounts. For example, the mobile application may generate a social media post with an image of the current state of their digital avatar at a set time each day/week, etc., according to the user's preferences.

When a user logs into mobile application 108 the user may see their connected friends' digital avatars. In this manner, a user may be able to ascertain their friend's financial health, but without seeing the precise reason why. Consequently, each user's actual financial information (e.g., account balances, etc.) remains confidential. But a user may still be able to reach out to another user if their digital avatar looks sad, etc., to check in on their friend to see if they need assistance.

Machine learning models 122 may include the models that determine how a digital avatar should update based on a user's financial activity. Different machine learning models may be used depending on the preferences of the user, and multiple machine learning models may be used in some instances.

A digital avatar may include state values relating to appearance. For example, there may be an age value and an emotion value. The emotion value may be a set of values for each element of a face. Different financial actions may influence state values based on the type of action and context of the action. For example, machine learning models 122 may include a lookup table with tuples such as: {type of financial action, emotion identifier, positive or negative, change amount}. An action may have more than one entry in the lookup table. For example, checking a balance may include an entry for a “happiness” emotion state to increase by one and an entry for an “angry” emotion state to decrease by two.

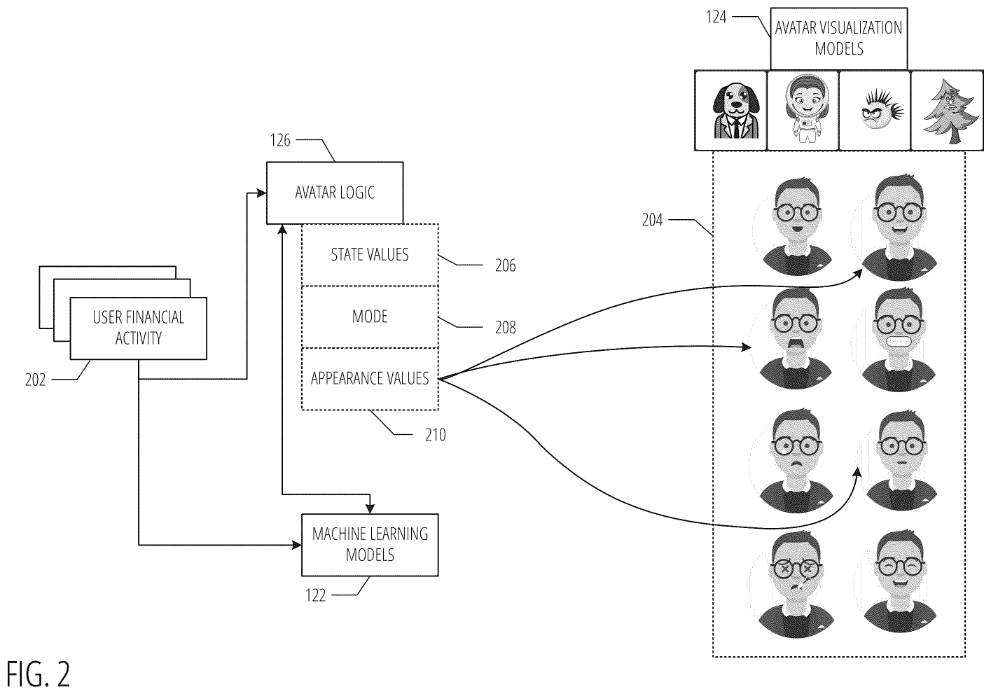

In addition to explicit user actions, a machine learning model may also use inaction as an input as well. For example, the lookup table may include an entry that indicates if a user has not checked their balance in a week to increase the sad emotion value by three. In various examples, the appearance of a digital avatar may be (at least partially) based on data stored within the user's profile. For example, a financial fluency score (e.g., how comfortable a user is with financial concepts) may influence the age value of the digital avatar. Accordingly, as the financial fluency increases, the age of the digital avatar increases as well. Further detail with respect to how a digital avatar's appearance is updated is discussed below in the context of FIG. 2

A user may choose to tie a digital avatar to a specific purpose. Often a user may have goals set associated with their account. For example, a user interface may be presented in mobile application 108 to create a new vacation savings goal of $5,000 within in next 12 months. As part of the goal creation process, the user interface may include a toggle/control, etc., for tying the goal to a digital avatar. If the user activates the toggle, the user interface may present different digital avatar types (e.g., a person, dog, etc.) to use for the goal. As an alternative mechanism, a user interface element may be presented that is configured to create a new digital avatar. The user may activate this element and select a digital avatar type. Then, an option may be presented to select an existing goal or use the digital avatar as a general financial health digital avatar. A user may have multiple digital avatars, in various examples.

When a digital avatar is tied to a goal, the types of actions that may influence the appearance may be limited compared to a general financial health digital avatar. For example, checking a balance may not affect the appearance of a goal digital avatar. However, there also may be actions that influence the appearance that would not affect a general financial health digital avatar. For example, if the user is on track to meet the goal (e.g., daily amount needed to save/days elapsed since goal started) may be used to update the happiness value of the digital avatar.

FIG. 2 is a schematic representation of processing user financial activity, according to various examples. FIG. 2 includes a machine learning models 122, an avatar visualization models 124, an avatar logic 126, a user financial activity 202, a 204, a state values 206, a mode 208, and an appearance values 210.

User financial activity 202 may include several categories of activity. For example, there may be account activity, purchase activity, education activity, among others. Account activity may include actions taken with respect to a user's account such as setting up bill pay, paying a bill, transferring money between accounts, missing a payment, setting up a budget, meeting a budget, exceeding a budget, etc. Purchase activity may be purchases made using an account of the user (e.g., online, in person, etc.). Education activity may include a user researching a stock or retirement plan. The above are only examples and more categories may be used as may be appreciated by one having one of skill in the art.

Application logic 112 may be an event driven model that responds to user financial activity 202. For example, the various types of financial activity may be triggered using APIs of application server 102. Thus, when the API call is received, application logic 112 may initiate processing of the user activity and an appearance update process for a digital avatar. Avatar logic 126 and machine learning models 122 may be used together to update the digital avatar, in various examples.

Avatar logic 126 may include state values 206, mode 208, and appearance values 210. State values 206 may include, but are not limited to, the last time a user logged in, an age trait value, a current emotion, or a goal identifier. Mode 208 may be a subset of state values 206 but is separately displayed for discussion purposes. Mode 208 may identify (e.g., using a Bool value) if the digital avatar is a goal-based or a general digital avatar—as discussed in more detail previously.

Appearance values 210 may be used to identify a current look of the digital avatar. The appearance values 210 may be depending on the visualization model of the digital avatar. For example, a digital avatar may be implemented with a series of static images—with each image representing a different emotional state. Accordingly, in this instance, appearance values 210 may be an identifier of the image file to use for the current value of the emotional state value.

In another example, a digital avatar may be a composite of multiple elements such as a face, eyes, nose, eyebrows, clothing, etc. Thus, appearance values 210 may include file identifiers for each of the components. If the digital avatar is a three-dimensional mode, appearance values 210 may include parameter values (e.g., size, location, texture, show/hide) for the components of the model. A lookup table may be stored that ties the current emotional state value to the appropriate appearance values 210. Consequently, if avatar logic 126 indicates a switch in emotion, the appearance of the digital avatar may be updated in accordance with the lookup table (e.g., using the emotion as an input/search query for the table).

In various examples, machine learning models 122 may use logic other than a lookup table. For example, Artificial intelligence (AI), machine learning (ML) algorithms, and Neural networks are often used interchangeably, but they are a set of nested concepts. Artificial intelligence may be considered the broadest concept and may be thought of as any program that attempts to perform a task/solve a problem that a human might such as facial recognition, classification, conversation, etc.

A subset of AI is ML. Machine learning encompasses different algorithms that are used to predict or classify a set of data used. In general terms, there are three types of ML algorithms: supervised learning, unsupervised learning, and reinforcement learning—sometimes a fourth, semi-supervised learning is also used.

Supervised learning algorithms may make a prediction based on a labeled data set (e.g., a user financial action and an emotion) and are generally used for classification, regression, or forecasting. Some examples of supervised learning algorithms are Naïve Bayes, Support Vector Machines, Linear Regression, Logistic Regression, Decision Trees, Random Forests, and K-Nearest Neighbor. Unsupervised learning algorithms may use an unlabeled data set (e.g., looking for clusters of similar data based on common characteristics). An example of an unsupervised learning algorithm is K-mean clustering.

Reinforcement learning algorithms generally make a prediction/decision, and then a user determines whether the prediction/decision was right-after which the machine learning model may be updated. This type of learning may be useful when a limited input data set is available.

Neural networks (also referred to an artificial Neural networks (ANN)) are a subset of ML algorithms that may be used to solve similar problems to those machine learning algorithms listed above. ANNs are computational structures that are loosely modeled on biological neurons. Generally, ANNs encode information (e.g., data or decision making) via weighted connections (e.g., synapses) between nodes (e.g., neurons). ANNs have many AI applications, such as automated perception (e.g., computer vision, speech recognition, contextual awareness, etc.), automated cognition (e.g., decision-making, logistics, routing, supply chain optimization, etc.), automated control (e.g., autonomous cars, drones, robots, etc.), among others.

Many ANNs are represented as matrices of weights that correspond to the modeled connections. Multiple matrices may be used when there are multiple layers. ANNs operate by accepting data into an input layer of neurons that often have many outgoing connections to neurons in another layer of neurons. One type of layer, a dense layer, is a layer in which each neuron in one layer is connected to each neuron in the next layer. If there are more than two layers, the layers between an input layer of neurons and an output layer of neurons are referred to as hidden layers. At each traversal between neurons, the corresponding weight modifies the input and may be tested against a threshold at the destination neuron. If the weighted value exceeds the threshold, the value is again weighted, or transformed through a nonlinear function, and transmitted to another neuron further down the ANN graph. If the threshold is not exceeded then, generally, the value is not transmitted to a down-graph neuron and the synaptic connection remains inactive. The process of weighting and testing continues until an output neuron is reached. The pattern and values of the output neurons constitutes the result of the ANN processing.

The correct (e.g., most accurate) operation of most ANNs relies on correct weights. However, ANN designers do not generally know which weights will work for a given application. Instead, a training process is used to arrive at appropriate weights. ANN designers typically choose a number of neuron layers or specific connections between layers including circular connection. A training process generally proceeds by selecting initial weights, which may be randomly selected.

Training data is fed into the ANN and results are compared to an objective function that provides an indication of error. The error indication is a measure of how wrong the ANN's result was compared to an expected result. This error is then used to correct the weights. Over many iterations, the weights will collectively converge to encode the operational data into the ANN. This process may be called an optimization of the objective function (e.g., a cost or loss function), whereby the cost or loss is minimized.

A gradient descent technique is often used to perform the objective function optimization. A gradient (e.g., partial derivative) is computed with respect to layer parameters (e.g., aspects of the weight) to provide a direction, and possibly a degree, of correction, but does not result in a single correction to set the weight to a “correct” value. That is, via several iterations, the weight will move towards the “correct,” or operationally useful, value. In some implementations, the amount, or step size, of movement is fixed (e.g., the same from iteration to iteration). Small step sizes tend to take a long time to converge, whereas large step sizes may oscillate around the correct value or exhibit other undesirable behavior. Variable step sizes may be attempted to provide faster convergence without the downsides of large step sizes.

Backpropagation is a technique whereby training data is fed forward through the ANN—here “forward” means that the data starts at the input neurons and follows the directed graph of neuron connections until the output neurons are reached—and the objective function is applied backwards through the ANN to correct the synapse weights. At each step in the backpropagation process, the result of the previous step is used to correct a weight. Thus, the result of the output neuron correction is applied to a neuron that connects to the output neuron, and so forth until the input neurons are reached.

Ultimately, the input to a neural network is in a numerical structure, a tensor. A tensor may have any number of dimensions. A zero-dimensional tensor is referred to as a scalar, a one-dimensional tensor is a vector, a two-dimensional tensor may be a matrix, and anything beyond three dimensions may just referred to as a tensor. The shape of a tensor may indicate the number of elements in each dimension.

In the context of determining an emotional state of a digital avatar, a training dataset may be used. The dataset may identify an event (e.g., a user financial action) and values (e.g., 0-1) for each possible emotional state. In various examples, an input tensor may include multiple characteristics of the user at the time of the action. Accordingly, elements of the tensor may be [balance of checking account, last time a user checked their balance, whether or not the user is on track for retirement . . . ]. The output layer may represent each of the possible emotional states of the digital avatar. Thus, after training, an input tensor may be used with the user financial activity and the characteristics. The values of the output nodes may represent the closeness of the emotion. For example, if the output nodes represent happy, sad, angry, neutral and the values are [0.3,0.1,0, 0.7], the appearance of the digital avatar may be set to neutral since it is the highest value.

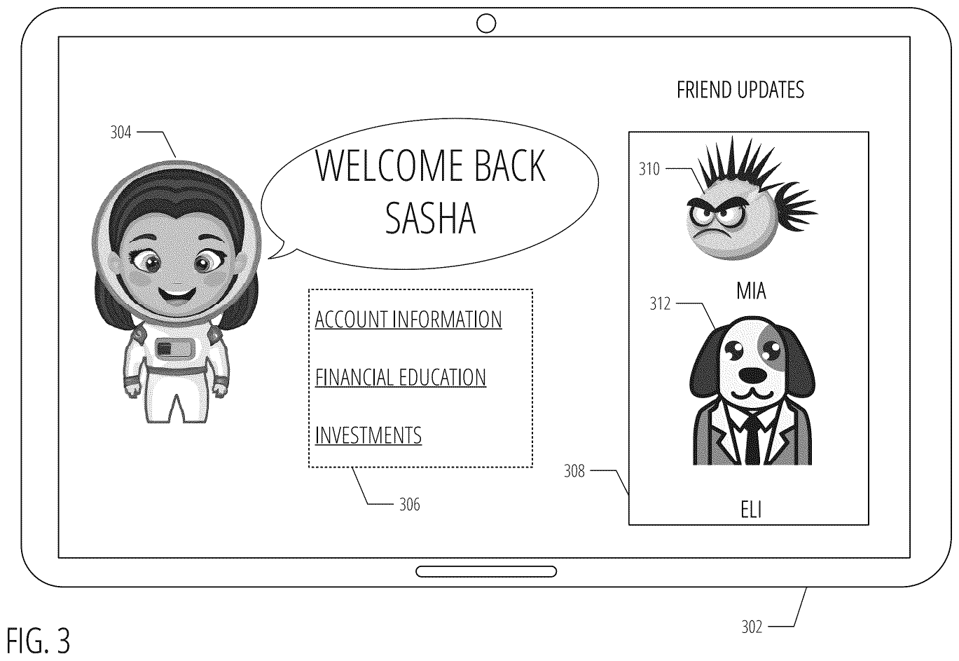

FIG. 3 is a user interface 300, according to various examples. FIG. 3 includes a client device 302, a digital avatar 304, a user actions 306, a friend update section 308, a digital avatar 310, and a digital avatar 312. Client device 302 may be a device such as client device 104. The user interface may be rendered by an application such as mobile application 108, which is in communication with application server 102.

User interface 300 may be the result of a user logging in to the application using their credentials. In response to logging in, application logic 112 may retrieve the digital avatar associated with the user's account (e.g., by issuing a query to a database). The digital avatar is represented as digital avatar 304 in user interface 300.

The appearance of digital avatar 304 may be set according to the appearance values of digital avatar 304. In the current example, digital avatar 304 is in a “happy” state, and thus a stored image file of the digital avatar in a happy state may be retrieved and presented. User interface 300 may also include user actions 306. Depending on an action selected by the user, the appearance values of digital avatar 304 may change and a new image file may be retrieved as discussed previously.

User interface 300 may also present friend update section 308, which includes digital avatar 310 and digital avatar 312. The digital avatars presented in friend update section 308 may of those friends that are connected to the current logged in user. Thus, Sasha may be able to tell that Mia's financial situation is not great, as evidenced by the frown of digital avatar 310. In contrast, digital avatar 312 shows a neutral emotion. In various examples, a user may select digital avatar 310 to initiate a messaging session with the associated account (e.g., Mia).

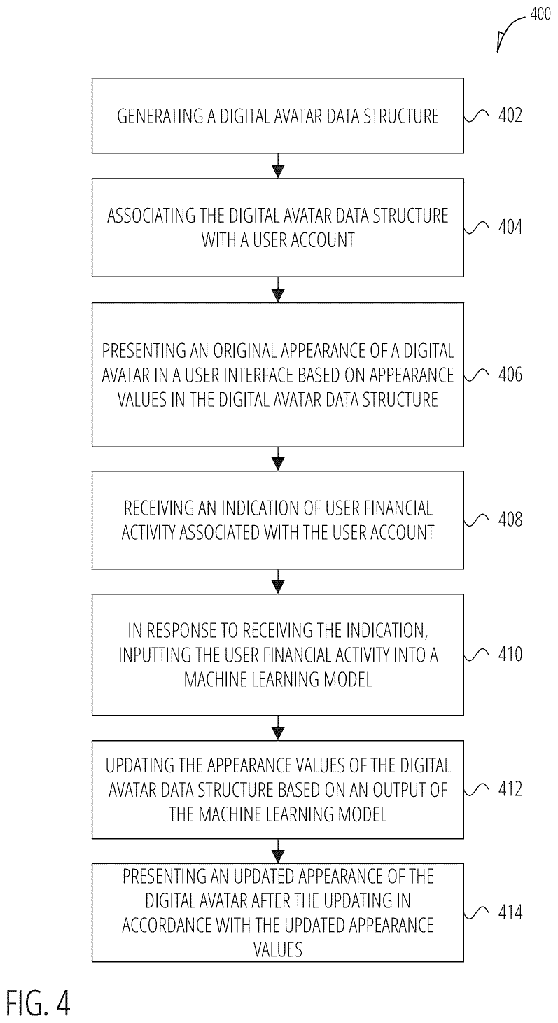

FIG. 4 is a flowchart illustrating a method to compare objects in a knowledge graph, according to various examples. The method is represented as a set of blocks that describe operations 402-414. The method may be embodied in a set of instructions stored in at least one computer-readable storage device of a computing device(s). A computer-readable storage device excludes transitory signals. In contrast, a signal-bearing medium may include such transitory signals. A machine-readable medium may be a computer-readable storage device or a signal-bearing medium. The computing device(s) may have one or more processors that execute the set of instructions to configure the one or more processors to perform the operations illustrated in FIG. 4. The one or more processors may instruct other component of the computing device(s) to carry out the set of instructions. For example, the computing device may instruct a network device to transmit data to another computing device or the computing device may provide data over a display interface to present a user interface. In some examples, performance of the method may be split across multiple computing devices using a shared computing infrastructure.

In various examples, operation 402 includes generating, by a processing unit, a digital avatar data structure. Operation 402 may be the result of a user logging into mobile application 108 and selecting a presented option to create a new digital avatar. As part of the selection process, the user may select a character type (e.g., as presented in avatar visualization models 124 of FIG. 2). The user may also tie (e.g., select a goal from a list of goals) the digital avatar to an existing goal in various examples.

As part of the digital avatar data structure, an age value may be assigned. A default value may be a one, on a scale of one to ten, in various examples. The age may be updated based on a financial education level value in the user account. Different financial education level values may correspond to different ages for the digital avatar.

In various examples, operation 404 includes associating, by the processing unit, the digital avatar data structure with a user account. Associating may mean storing an identifier of the digital avatar data structure in the user account profile information.

In various examples, operation 406 includes presenting, by the processing unit, an original appearance of a digital avatar in a user interface based on appearance values in the digital avatar data structure. The process of generating and updating an appearance may be one such as discussed in the context of FIG. 2. For example, a lookup table may be used to retrieve an appearance of the digital avatar. In various examples, the appearance is influenced by the age as well. For example, there may be stored image files for a “happy” version of the digital avatar at different ages.

In various examples, operation 408 includes receiving, by the processing unit, an indication of user financial activity associated with the user account. User financial activity may include positively taken action or the absence of action taken for a period of time. Positively taken actions may include opening their account on mobile application 108, transferring money, paying a bill, etc. Absence of action taken may include missing a bill payment or not checking their account balance for a week, etc.

In various examples, operation 410 includes in response to receiving the indication, inputting, by the processing unit, the user financial activity into a machine learning model. Inputting may include generating a feature vector, querying a database table, etc., depending on the type of machine learning model.

In various examples, operation 412 includes updating, by the processing unit, the appearance values of the digital avatar data structure based on an output of the machine learning model. The output of the machine learning model may be different depending on the configuration of the machine learning model. For example, if the machine learning model is configured as a set of logic rules, the output may be an emotion. If the machine learning model is a neural network, the output may include an array of values, one for each emotion (with higher values indicating higher relevance).

The computer-implemented method may also include where the output of the machine learning model identifies a change in value of an emotion value of the digital avatar data structure. For example, the output may indicate to increase the “happy” state value by one and decrease the “sad” state value by three.

The computer-implemented method may also include where updating, by the processing unit, the appearance values of the digital avatar data structure includes accessing a lookup table using the emotion as a query value. For example, if the emotion identified by the machine learning model is “sad” then “sad” (or a numerically assigned identifier representing “sad”) may be used to retrieve an image file or digital avatar appearance parameters.

In various examples, operation 414 includes presenting, by the processing unit, an updated appearance of the digital avatar after the updating in accordance with the updated appearance values.

The computer-implemented method may also include where the user account is a first user account and the method further includes receiving a request to connect with a second digital avatar of a second user account, transmitting an acceptance to the request to the second user account. The computer-implemented method may also include based on the acceptance, displaying the second digital avatar in the interface in accordance with appearance values of a second digital avatar data structure associated with the second digital avatar.

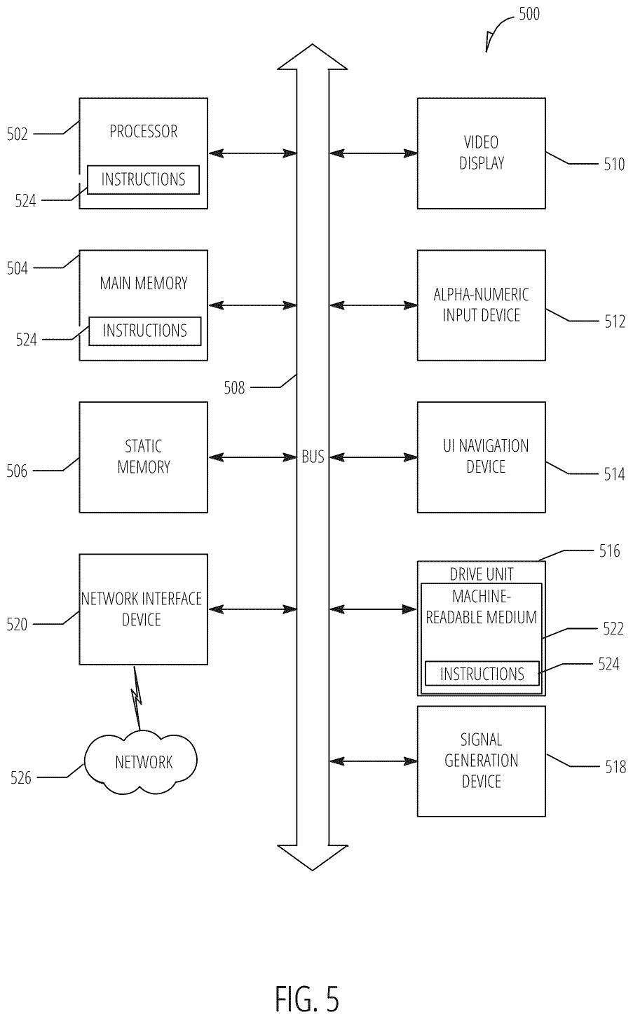

FIG. 5 is a block diagram illustrating a machine in the example form of computer system 500, within which a set or sequence of instructions may be executed to cause the machine to perform any one of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client Network environments, or it may act as a peer machine in peer-to-peer (or distributed) Network environments. The machine may be an onboard vehicle system, wearable device, personal computer (PC), a tablet PC, a hybrid tablet, a personal digital assistant (PDA), a mobile telephone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 500 includes at least one processor 502 (e.g., a central processing unit (CPU), a graphics processing unit (GPU) or both, processor cores, compute nodes, etc.), a main memory 504 and a static memory 506, which communicate with each other via a link 508. The computer system 500 may further include a video display unit 510, an input device 512 (e.g., a keyboard), and a user interface (UI) navigation device 514 (e.g., a mouse). In one embodiment, the video display unit 510, input device 512, and UI navigation device 514 are incorporated into a single device housing such as a touch screen display. The computer system 500 may additionally include a storage device 516 (e.g., a drive unit), a signal generation device 518 (e.g., a speaker), a network interface device 520, and one or more sensors (not shown), such as a global positioning system (GPS) sensor, compass, accelerometer, or other sensors.

The storage device 516 includes a machine-readable medium 522 on which is stored one or more sets of data structures and instructions 524 (e.g., software) embodying or utilized by any one or more of the methodologies or functions described herein. The instructions 524 may also reside, completely or at least partially, within the main memory 504, static memory 506, and/or within the processor 502 during execution thereof by the computer system 100, with the main memory 504, static memory 506, and the processor 502 also constituting machine-readable media.

While the machine-readable medium 522 is illustrated in an example embodiment to be a single medium, the term “machine-readable medium” may include a single medium or multiple media (e.g., a centralized or distributed Database, and/or associated caches and servers) that store the one or more instructions 524. The term “machine-readable medium” shall also be taken to include any tangible medium that is capable of storing, encoding, or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks. A computer-readable storage device may be a machine-readable medium 522 that excluded transitory signals.

The instructions 524 may further be transmitted or received over a communications network 526 using a transmission medium via the network interface device 520 utilizing any one of a number of well-known transfer protocols (e.g., HTTP). Examples of communication networks include a local area Network (LAN), a wide area Network (WAN), the Internet, mobile telephone networks, plain old telephone (POTS) networks, and wireless data networks (e.g., Wi-Fi, 3G, and 4G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplate are examples using any combination or permutation of those elements shown or described (or one or more aspects thereof), either with respect to a particular example (or one or more aspects thereof), or with respect to other examples (or one or more aspects thereof) shown or described herein.

1. A system comprising:
a processing unit; and
a storage device comprising instructions, which when executed by the processing unit configure the processing unit to perform operations comprising:
receiving a selection to create a digital avatar for a user account;
in response to receiving the selection:
receiving a selection of a visualization model of a plurality of visualization models for the digital avatar;
presenting a list of previously created goals associated with the user account;
receiving a selection of a goal from the list of goals;
based on the selection of the goal:
tying the digital avatar to the goal; and
limiting types of actions that influence the digital avatar; and
generating a digital avatar data structure for the user account;
presenting an original appearance of a digital avatar in a user interface based on appearance values in the digital avatar data structure;
receiving an indication of user financial activity associated with the goal of the user account;
in response to receiving the indication, inputting the user financial activity into a machine learning model;
updating the appearance values of the digital avatar data structure based on an output of the machine learning model; and
presenting an updated appearance of the digital avatar after the updating in accordance with the updated appearance values.

2. The system of claim 1, wherein the output of the machine learning model identifies an emotion.

3. The system of claim 2, wherein updating the appearance values of the digital avatar data structure includes:
accessing a lookup table using the emotion as a query value.

4. The system of claim 1, wherein the output of the machine learning model identifies a change in value of an emotion value of the digital avatar data structure.

5. The system of claim 1, wherein the digital avatar data structure includes an age value.

6. The system of claim 5, further comprising updating the age value of the digital avatar data structure based on a financial education level value in the user account.

7. The system of claim 1, wherein the user account is a first user account, and wherein the storage device further comprises instructions, which when executed by the processing unit, configure the processing unit to perform operations comprising:
receiving a request to connect with a second digital avatar of a second user account; and
transmitting an acceptance to the request to the second user account.

8. The system of claim 7, wherein the storage device further comprises instructions, which when executed by the processing unit, configure the processing unit to perform operations comprising:
based on the acceptance, displaying the second digital avatar in the interface in accordance with appearance values of a second digital avatar data structure associated with the second digital avatar.

9. A computer-implemented method comprising:
receiving, using a processing unit, a selection to create a digital avatar for a user account;
in response to receiving the selection:
receiving a selection of a visualization model of a plurality of visualization models for the digital avatar;
presenting a list of previously created goals associated with the user account;
receiving a selection of a goal from the list of goals;
based on the selection of the goal:
tying the digital avatar to the goal; and
limiting types of actions that influence the digital avatar; and
generating, by the processing unit, a digital avatar data structure for the user account;
presenting, by the processing unit, an original appearance of a digital avatar in a user interface based on appearance values in the digital avatar data structure;
receiving, by the processing unit, an indication of user financial activity associated with the goal of the user account;
in response to receiving the indication, inputting, by the processing unit, the user financial activity into a machine learning model;
updating, by the processing unit, the appearance values of the digital avatar data structure based on an output of the machine learning model; and
presenting, by the processing unit, an updated appearance of the digital avatar after the updating in accordance with the updated appearance values.

10. The computer-implemented method of claim 9, wherein the output of the machine learning model identifies an emotion.

11. The computer-implemented method of claim 10, wherein updating, by the processing unit, the appearance values of the digital avatar data structure includes:
accessing a lookup table using the emotion as a query value.

12. The computer-implemented method of claim 9, wherein the output of the machine learning model identifies a change in value of an emotion value of the digital avatar data structure.

13. The computer-implemented method of claim 9, wherein the digital avatar data structure includes an age value.

14. The computer-implemented method of claim 13, further comprising updating the age value of the digital avatar data structure based on a financial education level value in the user account.

15. The computer-implemented method of claim 9, wherein the user account is a first user account and the method further comprises:
receiving a request to connect with a second digital avatar of a second user account; and
transmitting an acceptance to the request to the second user account.

16. The computer-implemented method of claim 15, further comprising:
based on the acceptance, displaying the second digital avatar in the interface in accordance with appearance values of a second digital avatar data structure associated with the second digital avatar.

17. A non-transitory computer-readable medium comprising instructions, which when executed by a processing unit, configure the processing unit to perform operations comprising:
receiving a selection to create a digital avatar for a user account;
in response to receiving the selection:
receiving a selection of a visualization model of a plurality of visualization models for the digital avatar:
presenting a list of previously created goals associated with the user account;
receiving a selection of a goal from the list of goals;
based on the selection of the goal:
tying the digital avatar to the goal; and
limiting types of actions that influence the digital avatar; and
generating a digital avatar data structure for the user account;
presenting an original appearance of a digital avatar in a user interface based on appearance values in the digital avatar data structure;
receiving an indication of user financial activity associated with the goal of the user account;
in response to receiving the indication, inputting the user financial activity into a machine learning model;
updating the appearance values of the digital avatar data structure based on an output of the machine learning model; and
presenting an updated appearance of the digital avatar after the updating in accordance with the updated appearance values.

18. The non-transitory computer-readable medium of claim 17, wherein the output of the machine learning model identifies an emotion.

19. The non-transitory computer-readable medium of claim 18, wherein updating the appearance values of the digital avatar data structure includes:
accessing a lookup table using the emotion as a query value.

20. The non-transitory computer-readable medium of claim 17, wherein the output of the machine learning model identifies a change in value of an emotion value of the digital avatar data structure.
